(19) United States
(12) Patent Application Publication
(10) Pub. No.: US 2015/0078134 A1
(43) Pub. Date: Mar. 19, 2015

(54) SONAR TYPE OBJECT DETECTION SYSTEM AND ITS IMPLEMENTING METHOD

(71) Applicant: Hsu-Yung YU, Taipei City (TW)

(72) Inventor: Hsu-Yung YU, Taipei City (TW)

(21) Appl. No.: 14/026,115

(22) Filed: Sep. 13, 2013

(51) Int. Cl. G01S 15/06

(52) U.S. Cl. CPC G01S 15/06
USPC 367/107; 367/99

(57) ABSTRACT

A sonar type object detection system and its implementing method are provided, whereby a physical object within a certain range can be detected after implementing by an operator. The present invention is mainly formed by a sonar application program unit, a voiceprint data base, and a mobile electronic device combined therewith. The present invention employs the principle of active sonar, in which a sonar module is used to transmit detective soundwaves and simultaneously to collect the reflective soundwaves of the detective soundwaves bouncing from physical object. Then, the reflective soundwaves are compared with the voiceprint data stored in the voiceprint data base, and the relative position of the object to be found is displayed directly on the screen of the mobile electronic device.

### BACKGROUND OF THE INVENTION

1. Field of the invention

The present invention relates to a sonar object detection system for searching the relative position of a physical object, more particularly to a sonar object detection system combined with a mobile electronic device, which is operated by the comparison with a voiceprint data base as a basis so as to detect object precisely, and its implementing method.

2. Brief Description of Prior Arts

Currently, major application technology of portable electronic type object detection device is mainly focused on the RFID which conforms to demands of miniaturization and lightweight. In implementation, it is formed by a sensing device and at least one tag. Firstly, user has to stick the tag on a specific object such as a key or a handbag. As frequency alignment is already conducted on the tag and the sensing device in advance, the device can monitor a specific object actively to know whether it is within effective monitoring range. If the distance between the specific object and the sensing device is beyond a predetermined range, the sensing device will generate an alarm indication. However, this conventional technology is inconvenient in its implementation, as operator has to carry additional sensing device which pairs up with one or more tag(s). If the number of monitored object is more than one, operator is unable to know exactly which object is beyond effective monitoring range, when the sensing device issues an alarm indication. Furthermore, this object detection device can only issue alarm indication, and the relative position between the monitored object and the operator remains unknown. If the monitored object is blocked by the other object, then the user is still unable to detect the monitored object. Accordingly, the inventor of the present invention proposes to employ the application of ACOUSTIC principle as the basis for the sensing of object detection. After referring to concerned technologies known to the public, there are two types described as below:

(1) Bi-directional signal transmission type : a signal transmitter is cooperated with a signal receiver. That is to say, either a signal transmitter or a signal receiver has to be mounted on the monitored object itself so as to achieve bidirectional signal sensing effect, which means it is inconvenient in implementation. For example, if an operator want to search a TV remote controller within a certain range (such as in living room), but as the TV remote controller has neither signal transmitter nor signal receiver mounted therein in advance, the purpose of detecting object is apparently unable to be completed. Relevant technologies of this type are disclosed such as:

A Taiwanese Patent Gazette No. 200818845 entitled “Searching Method by Using Mobile Telecommunication Device and its Associated Mobile Telecommunication Device”;

A Taiwanese Utility Patent No. M395226 entitled “Searching-assisted Device with electronic Means for Object Detection”.

(2) Mono-directional signal transmission type : mainly the ultrasound principle is employed, concerned technologies are disclosed in, such as:

A US Patent Gazette No. 2013/0003502 entitled “Configurable Ultrasound Measurement Logic in a Mobile Computing”. However, this technology is confined in specific purpose, such as pulse rate of baby in womb, distance of a single target;

A Taiwanese Patent Gazette No. 201142820 entitled “Soundwave Indentifying System and Method” applied in specific material identification.

Based on above, it is apparent the current technologies are still unable to be used popularly in our daily life, so as to satisfy the demands of good portability and of finding out the object to be monitored on time and precisely for users.

### SUMMARY OF THE INVENTION

In view of the above demands, the main purpose of this invention is to provide a sonar type object detection system and its implementing method, which can satisfy the demands of good portability and of finding out the object to be monitored on time and precisely for users.

In order to achieve above purposes, the system according to the present invention employs the application of acoustic principle as the basis for the sensing of object detection, and takes advantage of sonar technology by incorporating a sonar application program unit and a voiceprint data base, so that users can undertake object detection operation promptly and conveniently. Moreover, the implementing method of the system according to the present invention employs the active sonar principle, in which a sonar module is used to transmit detective soundwaves and simultaneously to collect the reflective soundwaves of the detective soundwaves bouncing back from the physical object. Then, the reflective soundwaves are compared with the voiceprint data stored in the voiceprint data base, and the relative position of the object to be found is displayed directly on the screen of the mobile electronic device.

### BRIEF DESCRIPTION OF ACCOMPANYING DRAWINGS

The present invention will be better understood by the detailed description of a preferred embodiment with reference to the accompanied drawings, in which:

FIG. 1 is a schematic view showing the structure of the system of the present invention;

FIG. 2 is a schematic view showing the implementing method of the present invention;

FIG. 3 is a schematic view showing the flowchart of the implementing method of the present invention;

FIG. 4 is a schematic view showing the operation (I) of the present invention;

FIG. 5 is a schematic view showing the operation (II) of the present invention;

FIG. 6 is a schematic view showing the operation (III) of the present invention;

FIG. 7 is a preferred embodiment (I) of the present invention;

FIG. 8 is another preferred embodiment (II) of the present invention;

FIG. 9 is still another embodiment (III) of the present invention.

### DETAILED DESCRIPTION OF PREFERRED EMBODIMENTS

The technical contents, objects and effects of the present invention will become more apparent by the detailed description of some preferred embodiments in conjunction with the accompanied drawings.

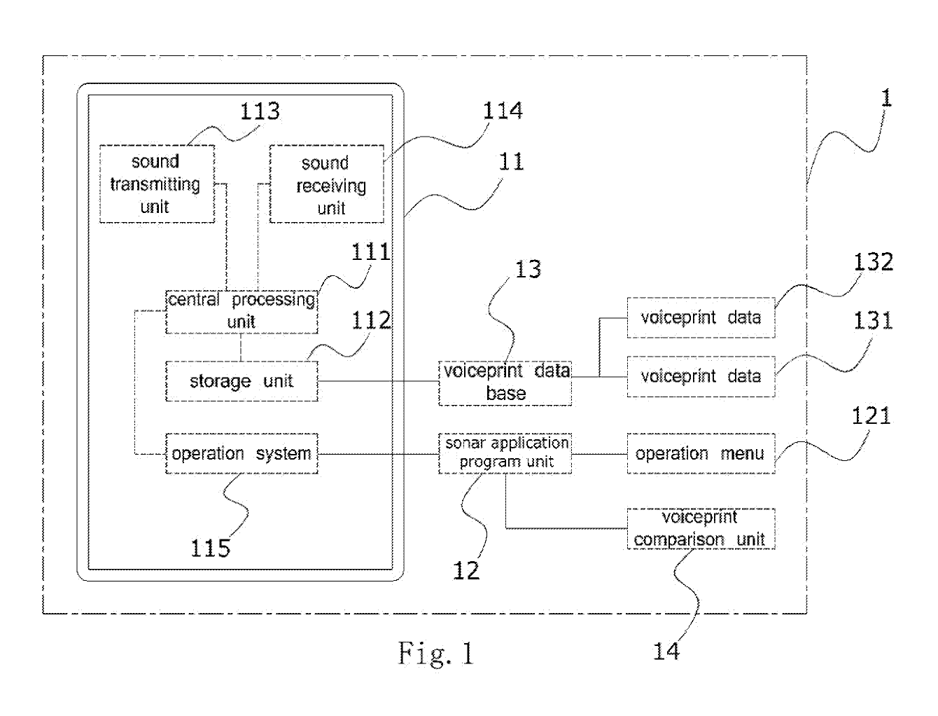

Referring to FIG. 1, a sonar type object detection system according to the present invention comprises a mobile electronic device 11, a sonar application program unit 12, a voiceprint data base 13, and a voiceprint comparison unit 14.

The mobile electronic device 11 includes, at least, a central processing unit 111, a storage unit 112, a sound transmitting unit 113 and a sound receiving unit 114. In addition, the mobile electronic device 11 also has an operation system installed therein.

The sonar application program unit 12 can be either an application program installed in advance in the operation system 115 of the mobile electronic device 11, or in the form of a chip having application program built therein and assembled in the mobile electronic device 11. The sonar application program unit 12 can generate an operation menu 121 which can be operated by a user to drive the sound transmitting unit 113 of the mobile electronic device 11, and simultaneously to drive the sound receiving unit 114 becoming actuated. Furthermore, the sonar application program unit 12 can be downloaded and installed in the mobile electronic device 11, such as smartphone, a tablet, a NB or a PC etc., and the sonar application program unit 12 can detect whether the hardware arrangement can meet the requirement for executing the application program. Moreover, the sonar application program unit 12 can have self-learning function which can record habits of a user.

The voiceprint data base 13 can be either stored in advance in the storage unit 112 of the mobile electronic device 11, or can be obtained by linking to a voiceprint data base of a server through internet (including synchronous downloading), and the voiceprint data base 13 is in information linking with the sonar application program unit 12. The voiceprint data base 13 mainly has a plurality of voiceprint data (131,132 . . . ) of different wavelengths stored therein, such as the voiceprint data of reflective soundwave of mosquito.

The voiceprint comparison unit 14 is in information linking with the sonar application program unit 12 so as to conduct the comparison for checking the conformity between the collected reflective soundwaves and the predetermined voiceprint data. Furthermore, the comparison of voiceprint employs basic analysis method of atlas spectrum identification method and the widely used feature extraction method such as Mel-Frequency Central Coefficients (MFCC), but is not limited to this only. Further, information required for the voiceprint comparison unit 14, such as time duration, frequency, feature of resonance peak, feature of resonance valley, energy distribution, can be contained in the atlas spectrum.

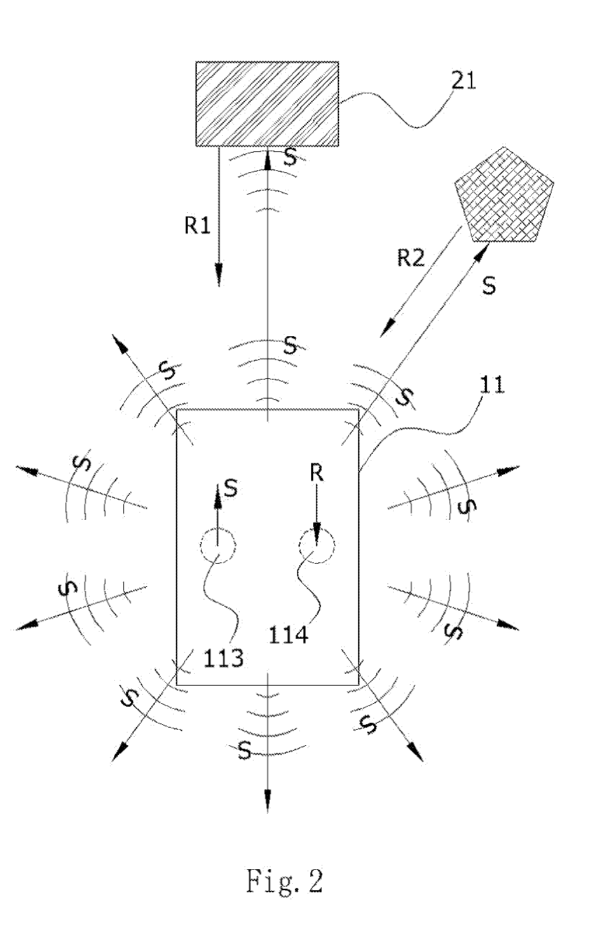

Referring to FIG. 2, when the sonar object detection system 1 is operated, the sound transmitting unit 113 of the mobile electronic device 11 can transmit a detective soundwave S having a specific length intermittently. When the detective soundwave S hits any physical object 21, such as wall surface or desk, a reflective soundwave R is immediately generated. At this moment, the sound receiving unit 114 of the mobile electronic device 11 can receive each of the reflective soundwaves R.

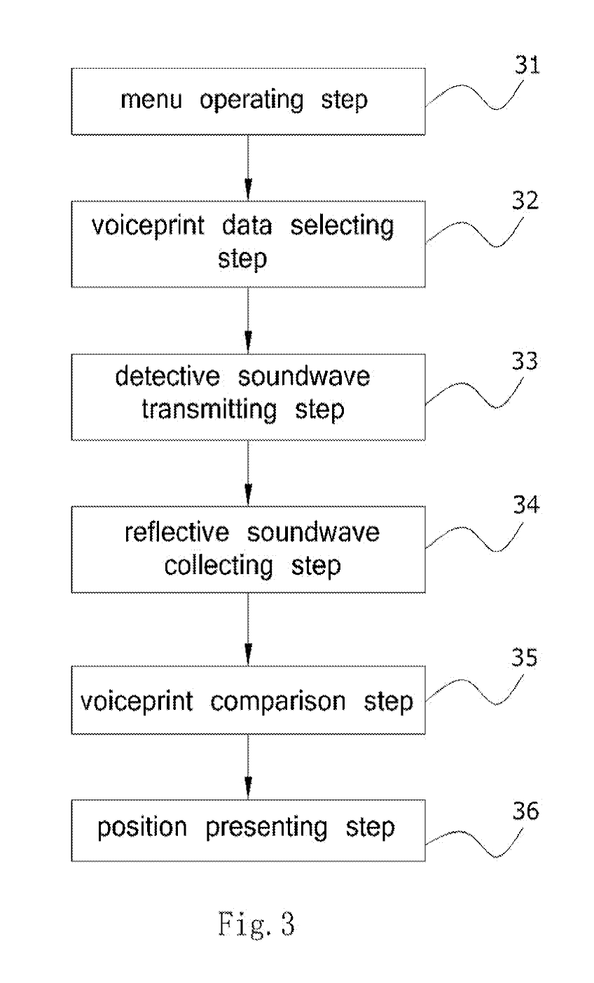

Referring to FIG. 3 and FIGS. 4 to 6, the steps of implementing the system of the present invention are described as below:

A menu operating step 31: an operator actuates the sonar application program unit 12 of the mobile electronic device 11, and then the operation menu 121 can be displayed on the screen of the mobile electronic device 11 (also referring to FIG. 1);

A voiceprint data selecting step 32 : on the frame of the operation menu 121, user can select one or a plurality of voiceprint data 131 stored in the voiceprint data base 13 according to his selected physical object 21 to be found. For example, if the operator want to search his handbag, then he (she) can find the voiceprint data of “handbag” stored beforehand in the voiceprint data base 13, for example he (she) can be select the voiceprint data according to the shape or the material of the object;

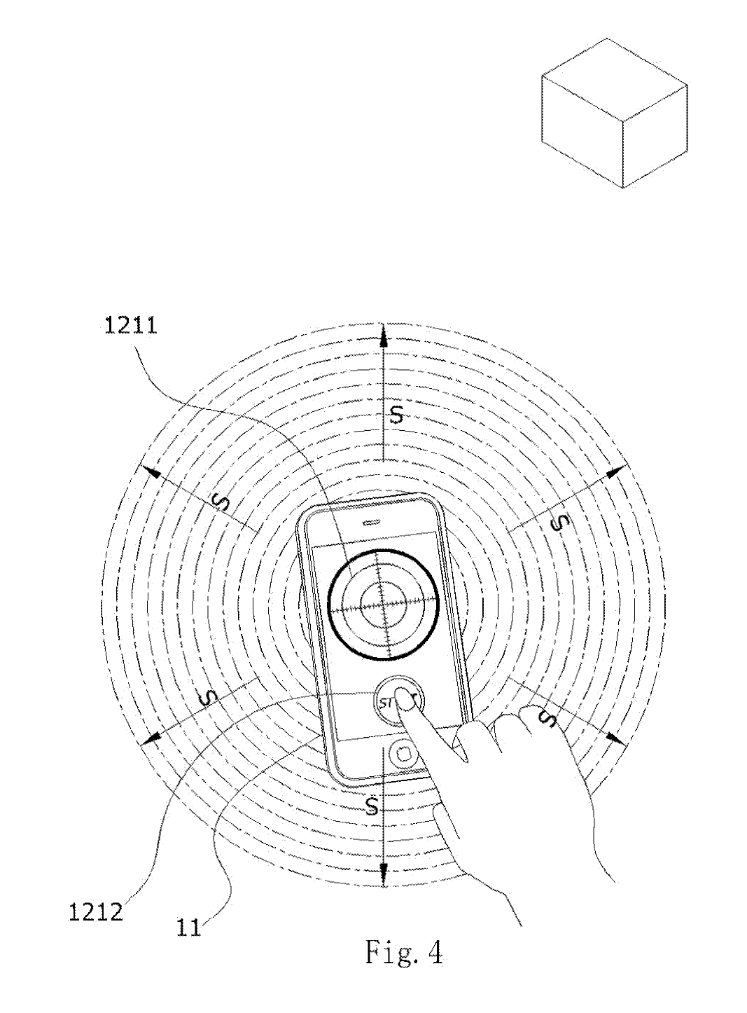

A detective soundwave transmitting step 33: to be continue from above, the operator can, in turn, hit on the screen of the operation menu 121 (for example, the hitting zone 1212 in the figure), so that the sonar application program unit 12 actuates the sound transmitting unit 113 of the mobile electronic device 11 to transmit a detective soundwave S intermittently. This operation method is an example only, not for limitation on the range of the present invention. For example, operator merely has to hit the hitting zone 1212 one time so that the sonar application program unit 12 can transmit intermittent detective soundwaves S in successive manner. Alternatively, users can hit continuously so that the sonar application program unit 12 can transmit intermittent detective soundwaves S in successive manner, as shown in FIGS. 1 and 4;

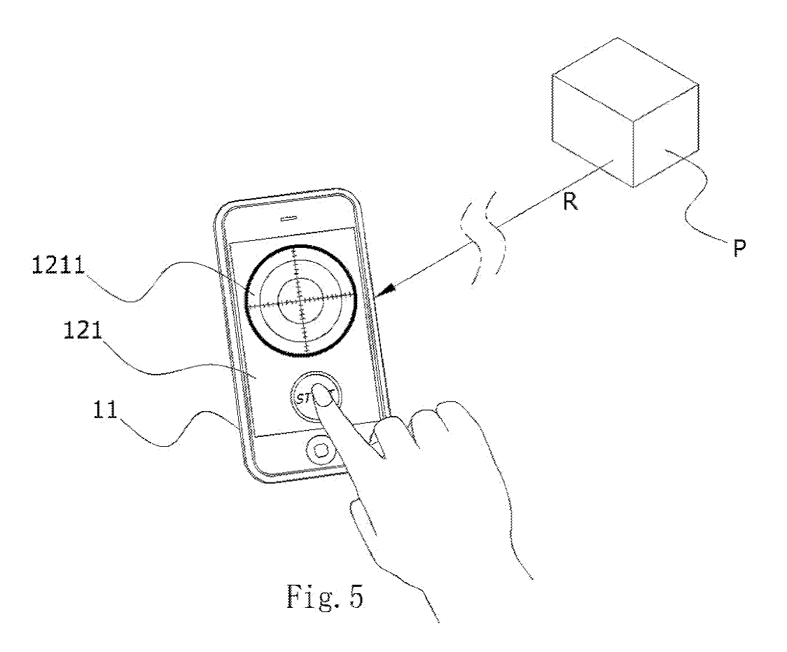

A reflective soundwave collecting step 34: to be continued, when the detective soundwave S hits any physical object P at site, a reflective soundwave R is generated and the wavelength (or voiceprint) of the reflective soundwave R varies according to the difference in material of the physical object P. As shown in the figure, when the detective soundwave S hits the physical object P, a plurality of reflective soundwaves (R1,R2 . . . ) are generated, then the sound receiver unit 114 receives each of the reflective soundwaves (R1,R2 . . . ) bouncing back from the site, as shown in FIGS. 1 and 5;

A voiceprint comparison step 35: next, the voiceprint comparison unit 14 conducts comparison for checking the conformity between each of the reflective soundwaves R and the voiceprint data 131 which has been selected in the voiceprint data selecting step 32;

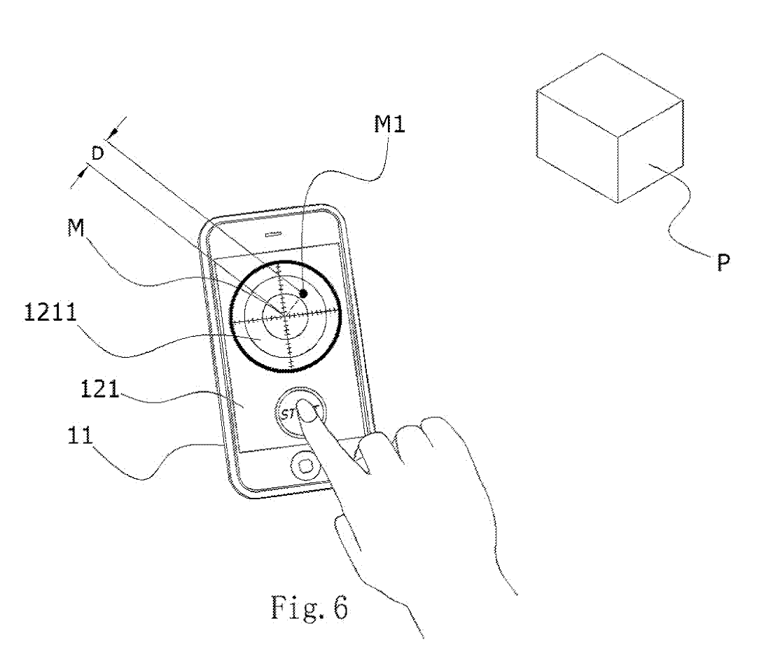

A position presenting step 36: next, when one of the reflective soundwaves R conforms to the predetermined voiceprint data 131 after comparison, the position of the physical object P to be found is emerged. Furthermore, the central processing unit 111 calculates out the relative distance D between the physical object P to be found and the mobile electronic device 11, and then an icon M1 is produced on a basic range display zone 1211 of the operation menu 121, as shown in FIG. 6. The central position M of a cross axis presented in the basic range display zone 1211 is the position of the mobile electronic device 11, while the position displaying the icon M1 is the relative position of the physical object P and the mobile electronic device 11.

In this manner, operator can quickly find out the physical object P according to the icon M1 presented on the basic range display zone 1211.

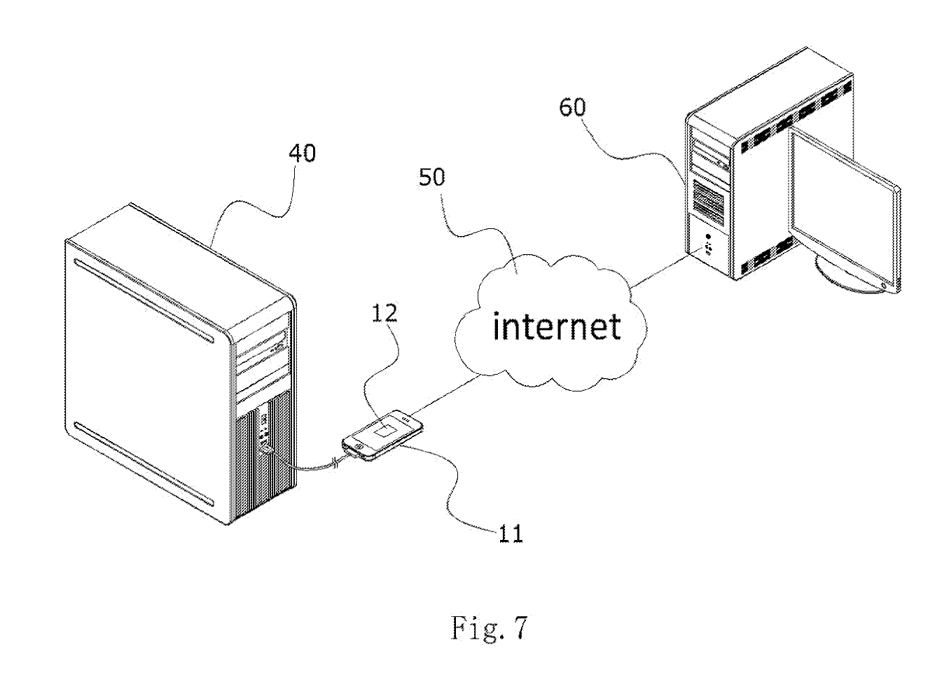

Referring to FIG. 7 and FIG. 1, the voiceprint data base 13 can be set up in many ways. The ways to expand the voiceprint data 131 stored in the voiceprint data base 13 have at least the ways described as below:

After the mobile electronic device 11 and a information device (for example, a computer) 40 are in information linking, the voiceprint data is classified through basic transmission format and given a name by the system, and is filed in the voiceprint data base 13 of the mobile electronic device 11;

The voiceprint data base 13 is connected to a server voiceprint data base 60 of a specific website through the internet 50, so as to carry out voiceprint data exchange and storage (uploading and downloading).

To be continued, the mode of downloading voiceprint data 131 by connecting to the server voiceprint data base 60 through the internet 50 can be carried out by incorporating a management and control mode, for example control by a specific account.

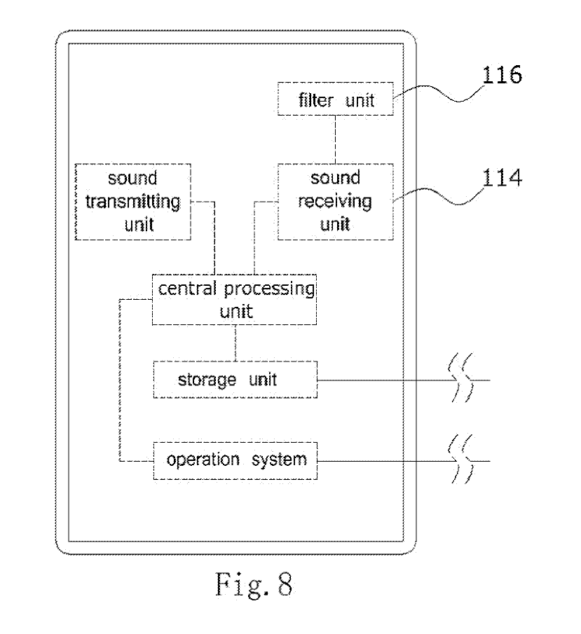

Referring to FIG. 8, in order to accelerate the voiceprint comparison step 35, a filter unit 116 is further provided in the present invention and the filter unit 116 is linked with the sound receiving unit 114. In this manner, when the voiceprint data selecting step 32 is carried out, the sonar application program unit 12 drives the filter unit 116 and the sound receiving unit 114 immediately. The filter unit 116 can filter out the reflective soundwaves that is beyong the frequency band of the pre-selected voice data 131, and allow only the reflective soundwave that conform the frequency band of the pre-selected voice data 131 to be received by the sound receiving unit 114. In this manner, the time required for comparison in the voiceprint comparison step 35 can be significantly reduced so as to accelerate the comparison speed.

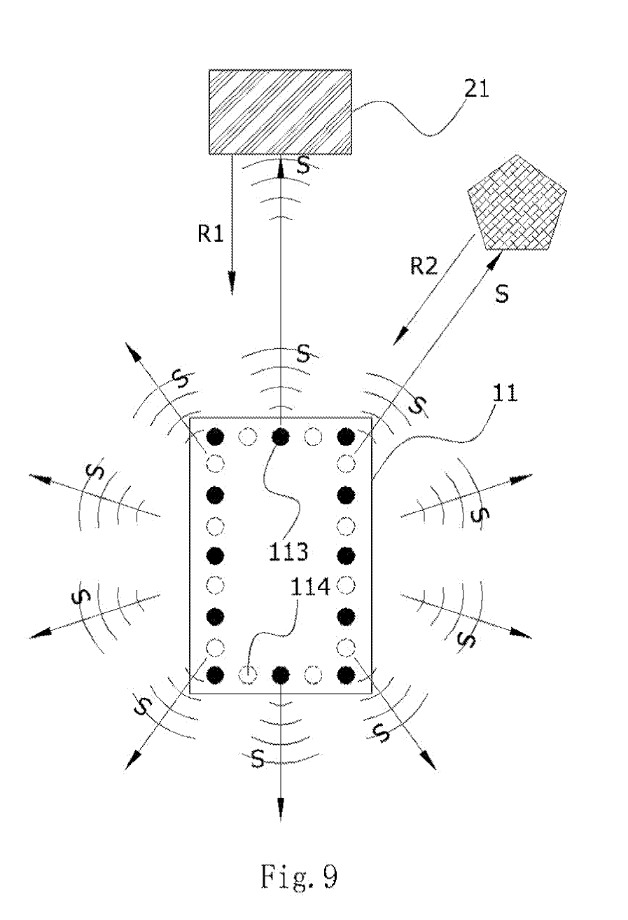

Referring to FIG. 9, the reflective soundwaves bouncing back from the object to be found are extremely possible to have multiple reflections in practical implementation. Therefore, the sound transmitting unit 113 and the sound receiving unit 114 according to the present invention can be multiple sets. The preferred implementing mode is to assemble the multiple sets sound transmitting units 113 and the sound receiving units 114 into, for example, matrix array. In this way, the relative position of the object to be found can be quickly calculated out conveniently. Moreover, the filter unit 116 can also be of multiple sets.

Based on foregoing, in the sonar type object detection system of the present invention, the mobile electronic device combined therewith can drive directly the sound transmitting unit (speaker) in the mobile electronic device so as to generate detective soundwave, and can drive the sound receiving unit (microphone) so as to receive reflective soundwaves. Further, the voiceprint comparison unit of the system is used to carry out voiceprint comparison, and the central processing unit of the mobile electronic device carries out the calculation of the relative distance, and the position of the physical object to be found is presented definitely as an icon on the basic range display zone provided by the sonar application program unit, so that operator can easily and quickly find out the object to be found according to the relative position and the distance. Furthermore, the implementing method mainly employs the active sonar principle, wherein a server voiceprint data base is connected in advance so that operator, when in operation, can select corresponding voiceprint in advance according to the physical object to be found, and then the mobile electronic device, through simple operation, can transmit detective soundwave. Further, after collection, comparison of each of the reflective soundwaves by the mobile electronic device and calculation on relative position, the relative position and the distance of the physical object to be found can be presented precisely. Based on foregoing, the present invention, after implementing according to the above description, can assuredly provide a sonar type object detection system which allows operator to quickly and precisely find out the monitored object, and its implementing method.

While the present invention has been described by preferred embodiments in conjunction with accompanying drawings, it should be understood the embodiments and the drawings are merely for descriptive and illustrative purpose, not intended to restrict the scope of the present invention. Equivalent variations and modifications conducted by persons skilled in the art without departing from the spirit and scope of the present invention should be considered to be still within the scope of the present invention.

1. A sonar type object detection system for detecting position(s) of one or a plurality of physical object(s) in a specific range, comprising:
a mobile electronic device at least formed by a central processing unit, a storage unit, a sound transmitting unit and a sound receiving unit, said mobile electronic device having an operation system installed therein;
a sonar application program unit installed in said operation system of said mobile electronic device, said sonar application program unit having an operation menu which is operated by users selectively to drive said sound transmitting unit of said mobile electronic device so as to transmit a detective soundwave, and simultaneously to drive said sound receiving unit to receive reflective soundwaves bouncing back from the site;
a voiceprint data base, which is stored in said storage unit of said mobile electronic device and in information linking with said sonar application program unit, said voiceprint data base having a plurality of voiceprint data with different wavelengths; and
a voiceprint comparison unit, which is in information linking with said sonar application program unit so as to conduct the comparison between each of the reflective soundwaves and each of said voiceprint data for checking the conformity.

2. The sonar type object detection system as claimed in claim 1, wherein said operation menu of said sonar application program unit has a basic range display zone for an icon to be presented thereon.

3. The sonar type object detection system as claimed in claim 1, wherein said operation menu of said sonar application program unit has a hitting zone for users to hit.

4. The sonar type object detection system as claimed in claim 1, wherein said sound transmitting unit and said sound receiving unit each has multiple sets.

5. The sonar type object detection system as claimed in claim 4, wherein said multiple sets sound transmitting units and the sound receiving units are formed into a matrix array.

6. The sonar type object detection system as claimed in claim 1, wherein a filter unit is connected to said sound receiving unit.

7. The sonar type object detection system as claimed in claim 1, wherein, after information linking is accomplisher between said mobile electronic device and an information device, a new voiceprint data is stored in said voiceprint data base.

8. The sonar type object detection system as claimed in claim 1, wherein said mobile electronic device is connected to the server voiceprint data base of a specific website so as to conduct voiceprint data exchange and storage.

9. The sonar type object detection system as claimed in claim 1, wherein said mobile electronic device is either one of a smartphone, a tablet, a NB or a PC.
